(19) United States
(12) Patent Application Publication
(10) Pub. No.: US 2026/0014712 A1
(43) Pub. Date: Jan. 15, 2026

(54) SENSORIZED ADHESIVE SKINS FOR UNDERWATER GRASPING OF OBJECTS

(71) Applicants: VIRGINIA TECH INTELLECTUAL PROPERTIES, INC., Blacksburg, VA (US); BOARD OF REGENTS OF THE UNIVERSITY OF NEBRASKA, Lincoln, NE (US)

(72) Inventors: Michael D. BARTLETT, Blacksburg, VA (US); Ravi Tej Anand TUTIKA, Christiansburg, VA (US); Eric MARKVICKA, Lincoln, NE (US)

(21) Appl. No.: 18/993,834

(22) PCT Filed: Jul. 13, 2023
(86) PCT No.: PCT/US2023/070128

§ 371 Date: Jan. 13, 2025

Related U.S. Application Data
(60) Provisional application No. 63/388,808, filed on Jul. 13, 2022.

(51) Int. Cl. B25J 15/06; B25J 1/02; B25J 9/16; B25J 13/08

(52) U.S. Cl. CPC B25J 15/0658; B25J 1/02; B25J 9/1697; B25J 13/086

(57) ABSTRACT

Various examples are provided related to underwater grasping of objects. In one example. an underwater adhesive system includes switchable adhesive elements, proximity sensing elements, and a controller. Each of the switchable adhesive elements can be pneumatically actuated to control adhesion or release of that switchable adhesive element. One of the switchable adhesive elements can be positioned adjacent to each of the proximity sensing elements. The controller can control adhesion of the switchable adhesive elements based at least in part upon signals from the proximity sensing elements.

### CROSS REFERENCE TO RELATED APPLICATIONS

This application claims priority to, and the benefit of, co-pending U.S. provisional application entitled “Sensorized Adhesive Skins for Underwater Grasping of Objects” having Ser. No. 63/388,808, filed Jul. 13, 2022, which is hereby incorporated by reference in its entirety.

### STATEMENT REGARDING FEDERALLY SPONSORED RESEARCH OR DEVELOPMENT

This invention was made with government support under grant no. 2119105 awarded by the National Science Foundation. The Government has certain rights in the invention.

### BACKGROUND

Strong and reversible attachment to underwater surfaces and objects is a significant challenge. Unlike dry environments where adhesives can utilize van der Waals forces, electrostatic forces, and hydrogen bonds, wet or underwater surfaces dramatically reduce the effectiveness of these mechanisms. Regardless, nature has numerous examples of organisms that have developed the ability to create strong attachment in moist or submerged environments. Mussels secrete specialized adhesive proteins and create an adhesive plaque to attach to moist surfaces, frogs channel fluid through structured toe pads to activate capillary and hydrodynamic forces, and cephalopods like the octopus utilize suckers to generate adhesion and suction forces. Cephalopod grippers are particularly attractive for underwater gripping as the adhesives are reversible, attachment can be activated quickly, and adhesion can be achieved on diverse substrates in dry and wet conditions. An additional sophistication in nature is a rich display of sensing and control that accompanies the adhesive system. The cephalopod sensing system consists of a photoreception vision system through their eyes; mechanoreceptors to detect fluid flow, pressure, and contact; and chemoreception tactile sensors. This capability provides information on attachment and proximity to objects, enabling the organism to display active gripping and releasing for efficient and reliable attachment. Moreover, an octopus can have over 2,000 suckers distributed across its 8 arms, where each adhesive is independently controlled to activate or release adhesion. This combination of adhesion tunability, sensing, and control is unmatched in synthetic adhesives.

### SUMMARY

Aspects of the present disclosure are related to underwater grasping of objects. An underwater adhesive system composed of switchable adhesive elements coupled with a sensory system, processing, and control for autonomous adhesive activation and release is introduced. The adhesive element can comprise a compliant, silicone stalk capped with a soft, pneumatically actuated membrane to control adhesion. These adhesive elements can be tightly integrated with an array of micro-LIDAR optical proximity sensors and a microcontrol for real-time object detection and control of adhesion. This tightly integrated system can mimic the nervous system, enabling the system to intelligently control multiple adhesive elements to achieve dexterous manipulation in dry and wet environments. When an object is sensed at a programmed distance, the adhesive membrane can be triggered. This enables autonomous activation of adhesion through a prescribed control loop for rapid attachment and controlled release by tuning the state of the membrane. By applying positive pressure, the membrane can be inflated for negligible adhesion; alternatively, by applying negative pressure the membrane can be retracted to increase the volume of the adhesive element at the interface, creating a suction pressure and enhancing adhesion.

In one aspect, among others, an underwater adhesive system comprises a plurality of switchable adhesive elements, each of the plurality of switchable adhesive elements pneumatically actuated to control adhesion or release of that switchable adhesive element; a plurality of proximity sensing elements positioned in proximity to the plurality of proximity sensing elements; and a controller communicatively coupled to the plurality of proximity sensing elements, the controller configured to control adhesion of the plurality of switchable adhesive elements based at least in part upon signals from the plurality of proximity sensing elements. In one or more aspects, the controller can autonomously control the adhesion of one or more of the plurality of switchable adhesive elements in response to the signals from one or more corresponding proximity sensing elements.

In various aspects, individual elements of the plurality of switchable adhesive elements can comprise a compliant stalk having a distal end capped with a pneumatically actuated membrane. The compliant stalk can be a silicon stalk. Application of a negative pressure can adhere the individual element to the object. Application of a positive pressure can release the individual element from the object. The individual element can be released from the object when the negative pressure is removed and a neutral pressure is reached. The plurality of proximity sensing elements can be an array. One of the plurality of switchable adhesive elements can be positioned adjacent to each of the plurality of proximity sensing elements. The plurality of proximity sensing elements can comprise optical proximity sensors. The optical proximity sensors can utilize laser-based sensing, camera-based vision sensing, or sound-based range sensing. The optical proximity sensors can comprise micro-LIDAR optical proximity sensors. In some aspects, the plurality of proximity sensing elements and the plurality of switchable adhesive elements can be integrated on a clothing surface or a device surface. The plurality of proximity sensing elements and the plurality of switchable adhesive elements can be integrated on a glove.

In another aspect, a switchable adhesive element comprises a compliant stalk extending from a support end affixed to a supporting surface to a contact end opposite the support end, the compliant stalk tapers outward at a stalk angle adjacent to the contact end; and an actuated membrane capping the contact end of the compliant stalk, the actuated membrane actuated in response to detection of a surface of an object by a proximity sensing element adjacent to the compliant stalk. In one or more aspects, the stalk angle can be about 15 degrees or more, or about 30 degrees or more. In various aspects, the actuated membrane can be pneumatically actuated. The actuated membrane can be pneumatically actuated via an air channel extending through the compliant stalk. Application of a negative pressure can adhere the switchable adhesive element to the surface of the object. The proximity sensing element can comprise an optical proximity sensor. The actuated membrane can be actuated in response to detection of the surface of the object being within a defined distance of the proximity sensing element. The compliant stalk can be an elastomer stalk.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A-1D illustrate an example of a switchable, sensorized underwater adhesive system, in accordance with various embodiments of the present disclosure.

FIGS. 2A-2D illustrate an example of characterization of a switchable underwater adhesive element, in accordance with various embodiments of the present disclosure.

FIGS. 3A-3G illustrate underwater adhesion strength, toughness, and release of a switchable underwater adhesive element, in accordance with various embodiments of the present disclosure.

FIGS. 4A-4E illustrate examples of adhesion under non-ideal conditions, in accordance with various embodiments of the present disclosure.

FIGS. 5A-5I illustrate an example of adhesive skin for intelligent underwater manipulation, in accordance with various embodiments of the present disclosure.

### DETAILED DESCRIPTION

Disclosed herein are various examples related to underwater grasping of objects. An octopus utilizes controllable adhesives with intricately embedded sensing, processing, and control to manipulate underwater objects. Current synthetic adhesive-based manipulators are typically manually operated without sensing or control, and can be slow to activate and release adhesion, which limits system level manipulation. Here, switchable, octopus-inspired adhesives can be combined with embedded sensing, processing, and control for robust underwater manipulation. Adhesion strength can be switched over 450× from the ON to OFF state in <50 ms over many cycles with an actively controlled membrane.

Systematic design of adhesive geometry can enable adherence to non-ideal surfaces with low preload and independent control of adhesive strength and adhesive toughness for strong and reliable attachment and easy release. A bio-inspired nervous system can be used to detect objects and autonomously trigger the switchable adhesives. This can be implemented into, e.g., a wearable glove where an array of adhesives and sensors can create a bio-mimetic adhesive skin to manipulate diverse underwater objects. Reference will now be made in detail to the description of the embodiments as illustrated in the drawings, wherein like reference numbers indicate like parts throughout the several views.

Switchable adhesives can generate strong adhesion yet can be removed on demand with a prescribed trigger and then can be reused. In these systems, a trigger, such as a mechanical, electromagnetic, fluidic, or thermal stimuli, results in a change in contact area, mechanical properties, or near interface characteristics to modulate adhesion. In the active, pressure driven systems observed in cephalopods, a pressure differential between the sucker chamber and the surrounding medium is created to generate a force used for attaching. The sucker can then be actuated again for release. This mechanism can function in dry or unsubmerged environments, allowing for attachment and release in diverse environments.

The characteristics and mechanisms of the cephalopod have inspired numerous mimics such as tentacle-like soft robotic grippers, passive and active microstructured surfaces, and active systems controlled by dielectric elastomer actuators and pneumatic pumps. However, cephalopods have a distinct advantage over synthetic adhesives as they have a prominent sensing system for proximity detection and mechanoreceptors to detect contact with surfaces, enabling active control of the adhesive elements. Sensing the proximity of a surface in synthetic systems that work in air and underwater can be achieved through a few different methodologies. This includes optical proximity sensors that utilize lasers or camera-based vision systems, and sound-based range sensors. However, the size of these sensor systems can limit their integration with synthetic adhesives, which limits manipulation or autonomous grasping capabilities in uncontrolled environments.

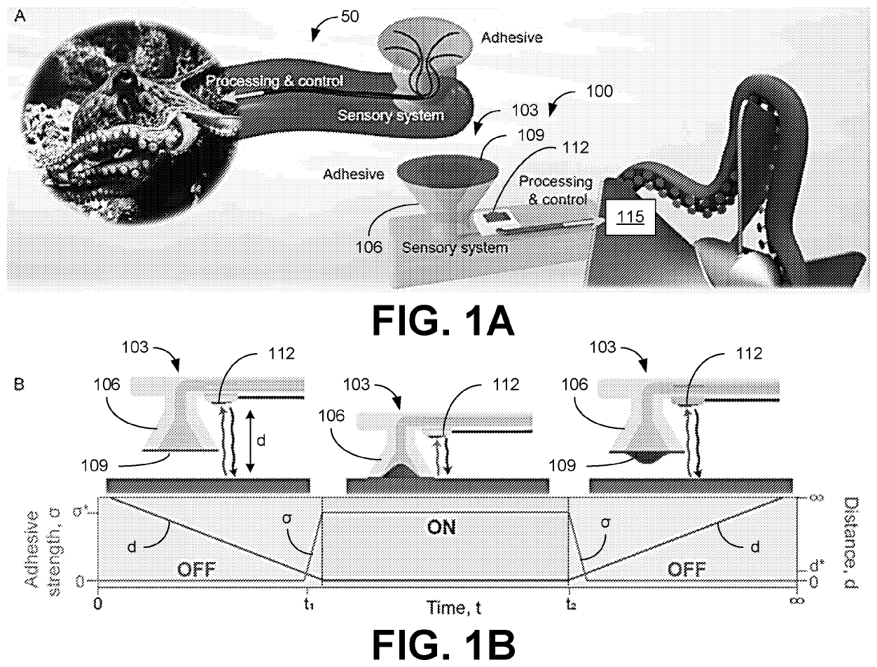

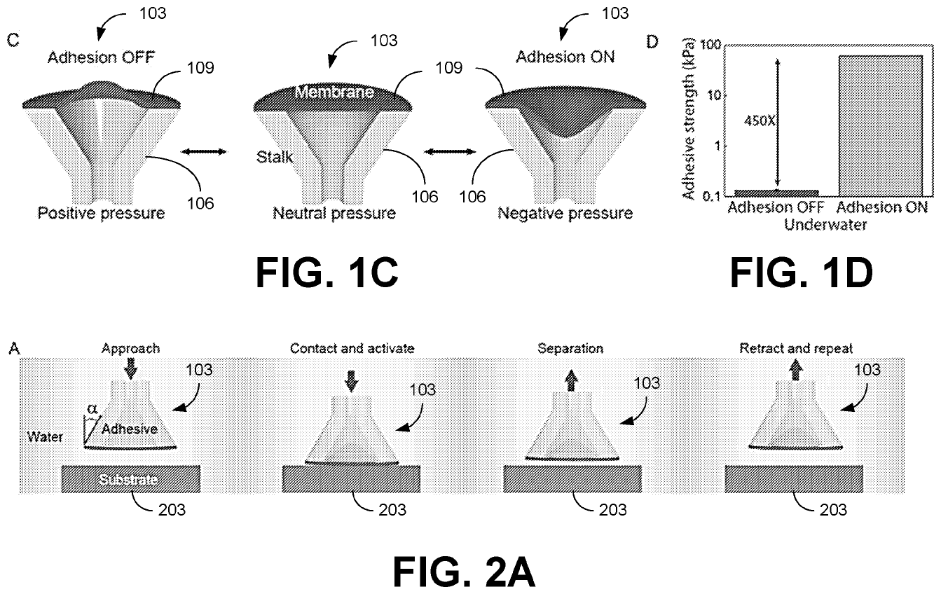

Here, an octopus-inspired underwater adhesive system composed of switchable adhesive elements coupled with a sensory system, processing, and control for autonomous adhesive activation and release is introduced. FIG. 1A illustrates the octopus's adhesive system 50 and an example of a sensorized, octopus-inspired adhesive system 100. As shown, the adhesive and sensory system 100 can be integrated with processing and control to sense objects and switch adhesion. In the example of FIG. 1A, the adhesive element 103 comprises a compliant, silicone stalk 106 capped with a soft, pneumatically actuated membrane 109 to control adhesion.

The adhesive elements 103 can be tightly integrated with, e.g., an array of micro-LIDAR optical proximity sensors 112 and a microcontrol 115 or other processing circuitry for real-time object detection and control of adhesion. This tightly integrated system 100 can mimic the nervous system, enabling the system 100 to intelligently control multiple adhesive elements 103 to achieve dexterous manipulation in dry and wet environments. When an object is sensed at a programmed distance (d*) the adhesive membrane 109 can be triggered. This enables autonomous activation of adhesion through a prescribed control loop for rapid attachment and controlled release by tuning the state of the membrane 109. FIG. 1B illustrates an example of the synthetic adhesive with an integrated micro-LIDAR optical sensor 112 where the adhesion goes from an OFF state to an ON state (at time t₁) with an adhesive strength σ* once the sensor 112 is triggered at a defined distance d*. The adhesion returns to the OFF state at time t₂, to release the element 103.

By applying positive pressure, the membrane can be inflated for negligible adhesion; alternatively, negative pressure can be applied to increase the volume of the adhesive element 103 at the interface, creating a suction pressure and enhancing adhesion. FIG. 1C schematically illustrates the different states of the pneumatically adhesive membrane 109 under positive, neutral, and negative pressure which controls the adhesion from an OFF to ON state. This octopus-inspired mechanism enables adhesive stresses greater than 60 kPa underwater, with an adhesive switching ratio over 450× from the ON to OFF state. FIG. 1D is a plot illustrating underwater adhesion results from an octopus-inspired adhesive, which shows an adhesion switching ratio of 450× from the ON to OFF state. Error bars represent the standard deviation for n=3. Reversibility was demonstrated over multiple cycles and rapid switching times <50 ms were achieved from a fully ON state to a released/OFF state.

By tuning sucker compliance through the stalk architecture, reliable attachment to off-angle substrates can be enabled with reduced preloads and with independent control of adhesive strength and work of separation providing reliable adhesion in non-ideal conditions. The tight integration of sensors, processing, and control with rapidly switchable adhesives creates new opportunities for dexterous manipulation of underwater objects in compact systems without prior knowledge of the environment. This functionality was demonstrated in a wearable adhesive glove where the ability to pickup and release a variety of items underwater (including flat, curved, rigid, and soft objects) was confirmed. These capabilities mimic the advanced manipulation, sensing, and control of cephalopods and provide a platform for synthetic underwater adhesive skins that can reliably manipulate diverse underwater objects.

### Switchable Adhesive Fabrication and Characterization

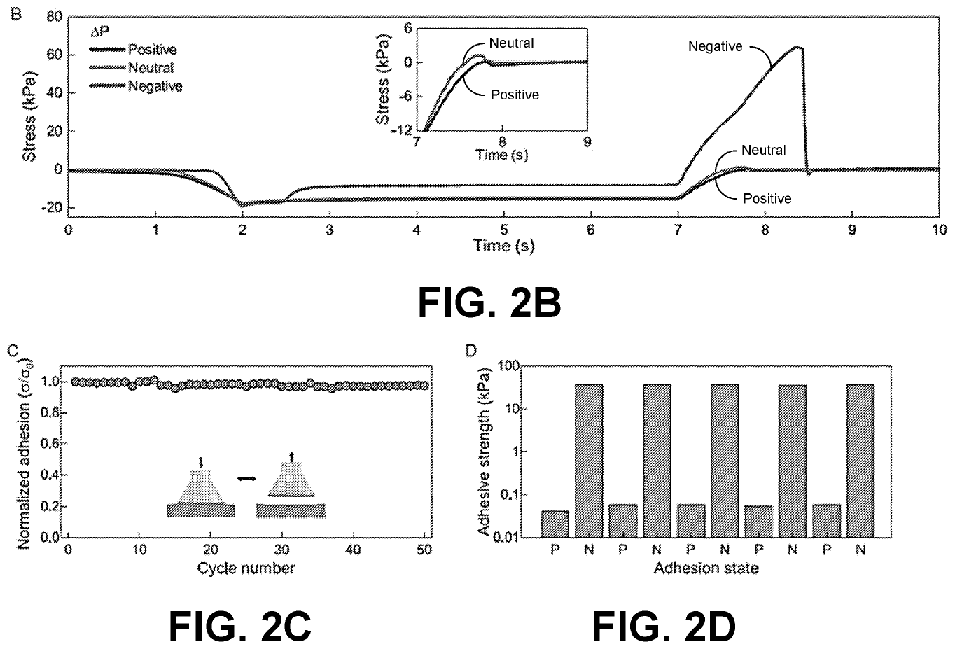

Adhesive elements 103 were made from silicone elastomers, with the stalk 106 being created with Dow Corning Sylgard 184 elastomer and the membrane 109 from a more deformable Smooth-On Dragon Skin elastomer to accommodate large deflections. The stalk 106 was fabricated using 3D printing molds with a prescribed geometry and then casting and curing the silicone elastomer. The stalk angle α is defined as the angle of the stalk near the contact surface as shown in FIG. 2A. The membrane 109 was cast, partially cured, and then bonded to the stalk 106. The adhesive element 103 was then connected to a pressure source that supplies positive, neutral, and negative pressure to control the shape of the active membrane 109.

Adhesion strength of the adhesive elements 103 was characterized for positive, neutral, and negative membrane pressurized states. This was performed on a custom testing setup that fully submerged the adhesive and substrate and pneumatically controlled the membrane state. FIG. 2A schematically illustrates the sequence of testing for an adhesive element 103 with negative pressure (ON state). First, the adhesive element 103 approached an acrylic substrate 203 until a predefined preload was reached. Next, a negative pneumatic pressure was applied to activate the adhesive membrane 109. The adhesive was then held in place for 5 seconds and subsequently pulled from the substrate until separation was achieve. The adhesive element 103 was retracted and the testing repeated as desired.

The results for a positive, neutral, and negative pressure on an adhesive element 103 with a stalk angle of α=15° are shown in FIG. 2B. The stress versus time plot displays the pre-load, dwell, and retraction data for three different pressurized states. Here, it can be seen that the negative state results in an adhesive stress of above 60 kPa. This contrasts with the low adhesive stresses for the positive and neutral states. The inset in FIG. 2B shows a zoomed in view of the pull off region of the plotted stress, indicating that the positive state produces a lower adhesive strength than the neutral state due to the inflation and reduced contact with the substrate 203. This mechanism functions in both dry and underwater conditions. Because soft elastomer materials are utilized for the membrane 109 and stalk 106, the adhesion is reversible and durable.

To demonstrate the reversibility of the adhesives, a cyclic experiment was performed where negative pressure was applied, and the adhesive strength was measured over 50 consecutive experiments. A stalk angle of α=15° was selected for the adhesive element 103 and, as shown in FIG. 2C, it was found that the adhesive was consistent over the tested cycles. The adhesive strength was normalized by the first cycle, and no degradation was observed over 50 cycles illustrating its reusability. By controlling adhesion through the active membrane 103, it is possible to rapidly switch between high and low adhesive states. The pneumatic system was programmed to first perform an experiment with positive pressure and then switch to a negative pressure for the next cycle. This results in the ability to actively switch between a low and high adhesion state repeatedly over 5 cycles for each state. FIG. 2D shows cyclic adhesion test of an α=15° adhesive element 103 alternating between positive and negative membrane states for high strength and release. Taken together, these results show the ability to generate significant adhesive strength underwater, to be reusable over many cycles, and to achieve reversible switching between high and low adhesive states.

### Switchable Adhesion Strength, Toughness, and Release

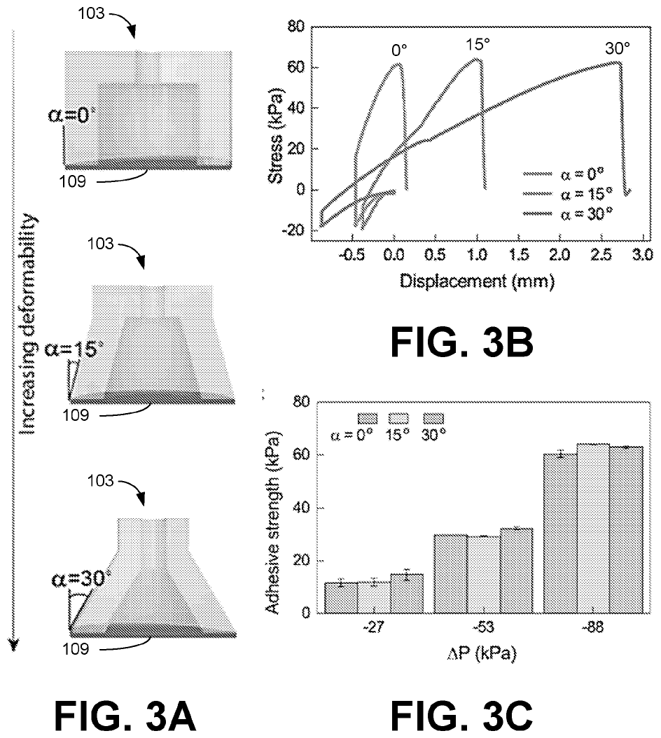

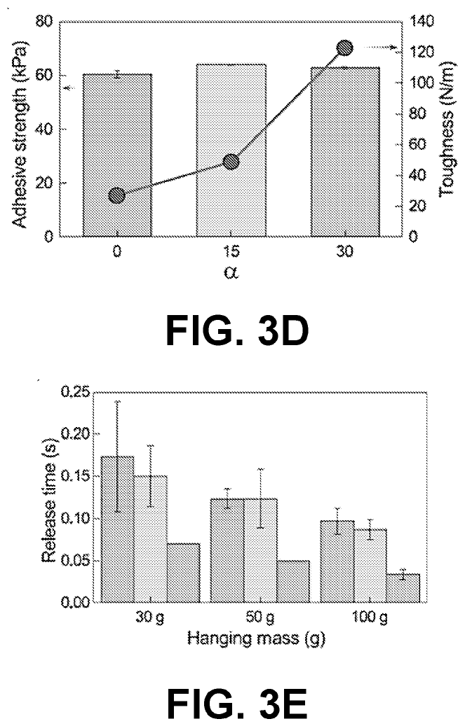

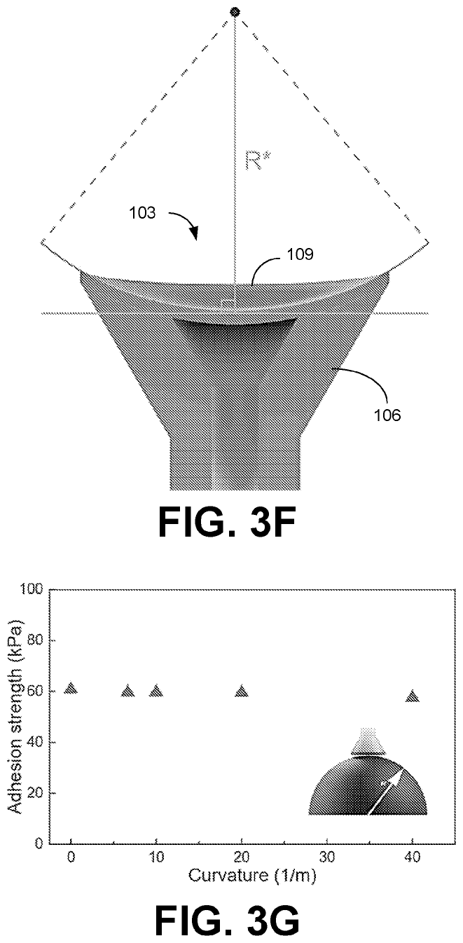

In unstructured environments, it is important that the adhesives are tolerant to angular misalignment. One way to improve contact creation is by increasing adhesive deformability. Here, the compliance of the adhesive elements can be tuned through stalk shape variation by changing the stalk angle (α). FIG. 3A shows adhesive elements where the stalk angle α varies between 0°, 15°, and 30° while maintaining a constant contact area and height. The effect of the stalk angle α on the ON state adhesive stress on a flat surface was first evaluated using an equivalent preload. FIG. 3B shows underwater contact adhesion experiments where changing a adjusts the compliance of the adhesive element 103 both as it is compressed and retracted. The graph represents the displacement versus adhesive force for each of the three stalk angles. Relative to the stiffness of the α=0 stalk, the stiffness during retraction decreases by a factor of 2.2× and 5.4× for the α=15° and 30°, respectively.

The deformation of adhesive elements 103 during retraction was further simulated in finite element (FE) analysis. These results show a decreasing stiffness with increasing stalk angle, where the stiffness decreases 5.1× as stalk angle changes from 0° to 30°, showing excellent agreement with the experimental results across this range. Both experiments and simulation show the ability to control contact compliance by changing the stalk angle.

The influence of α and pneumatic pressure (ΔP) on adhesive strength is shown in FIG. 3C for all three stalk angles under various negative pressures. First, for a given α, increasing the magnitude of the negative pressure results in greater adhesive strengths. This enables controllable adhesion strength by tuning the applied negative pressure. Pull-off velocity can also tune adhesive strength, where increasing adhesive strength was found with increasing pull-off velocity. Second, for a given ΔP, the adhesive strength remains the same irrespective of α. Even for the maximum negative pressure, a similar adhesive stress of greater than 60 kPa is found for all three stalk angles.

Testing went as low as −88 kPa in this study as it balanced the time to pump down, considerations for sealing, and negative pressure generation. Although all the samples have the same maximum adhesion strength, the compliant adhesive element 103 with α=30° is advantageous as it provides for a tougher adhesive and the ability to conform to different surfaces with angular misalignment. The toughness is evaluated by the overall work needed to remove the adhesive during separation. The most compliant sample of α=30° takes more work for removal even as the adhesive stress is the same as other angles. FIG. 3D is a plot showing the ability to achieve high adhesive strength and tunable adhesion toughness by changing the stalk angle α (data are for ΔP=−88 kPa.), where the black line with circular symbols refers to the toughness. This effective change in stiffness allows for the α=30° adhesive element 103 to exhibit a 4.6× higher work of fracture relative to the α=0° sample under the same loading conditions. This shows the capability to increase the work of fracture of the adhesive by changing the sample geometry without sacrificing adhesive strength.

The adhesives can also be switched from an ON state to an OFF state while supporting a load. Rapid switching performance for different stalk angles α=0°, 15° and 30° were examined using masses of 30, 50, and 100 grams. The underwater switching tests were preformed by lifting a mass in the negative pressure state and then switching to the positive pressure state. For this experiment, the positive pressure was approximately 5 kPa and the negative pressure was −88 kPa. This transition inflates the membrane to reduce the adhesion and rapidly drops the mass. The time needed to drop a mass after triggering the adhesion change was compiled. FIG. 3E shows the release times for three different masses for all three stalk angles. Error bars represent the standard deviation for n=3. The release time decreases for increasing mass, and that the α=30° shows the most rapid release. All stalk angles release the mass in less than 200 ms, with the adhesive element 103 with α=30° releasing the 100 g mass in less than 40 ms, showing the ability to rapidly switch from a high to low adhesion state underwater.

Taken together, these results show the ability to achieve high adhesion strength and toughness while also being able to rapidly (<0.1 s) and controllably switch adhesion to the OFF state. This combination of strength, toughness, and release is often contradictory in adhesives, yet is achieved here through the combination of stalk geometry and active control of membrane curvature in these soft, octopus-inspired adhesives. This represents an exceptional combination of underwater adhesion switching characteristics which is uniquely enabled by the ability to control deformation through the stalk geometry for toughness, while being able to actively control the membrane geometry for strength and rapid release.

The shape of the stalk can be modified by changing the curvature of the contacting surface with the membrane 109. FIG. 3F illustrates an example of the adhesive element 103 having a curvature with radius R. This configuration can improve the ability to create adhesion on curved surfaces, where a high adhesive strength (approximately 60 kPa) can be maintained as the surface becomes more curved. FIG. 3G is a plot showing the ability to maintain a high adhesive strength with different curvatures.

### Switchable Adhesion Under Non-Ideal Conditions

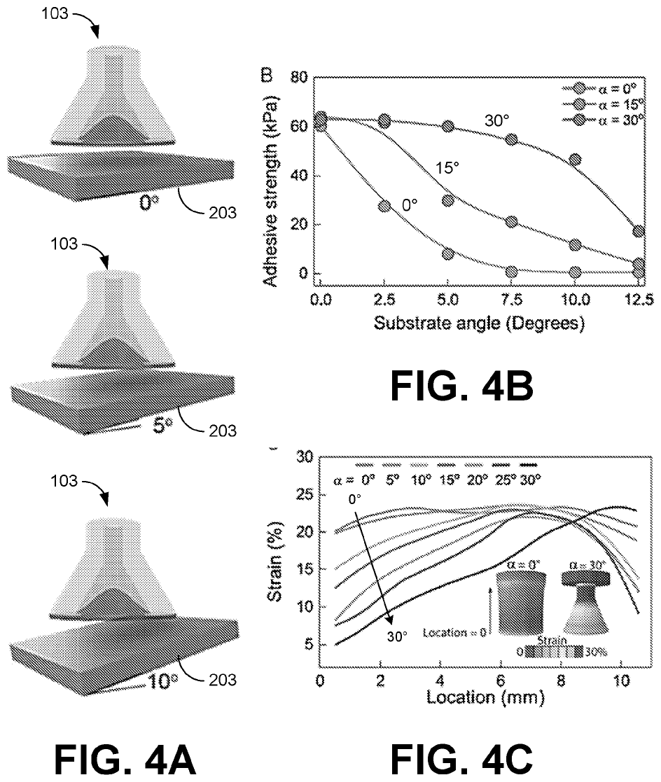

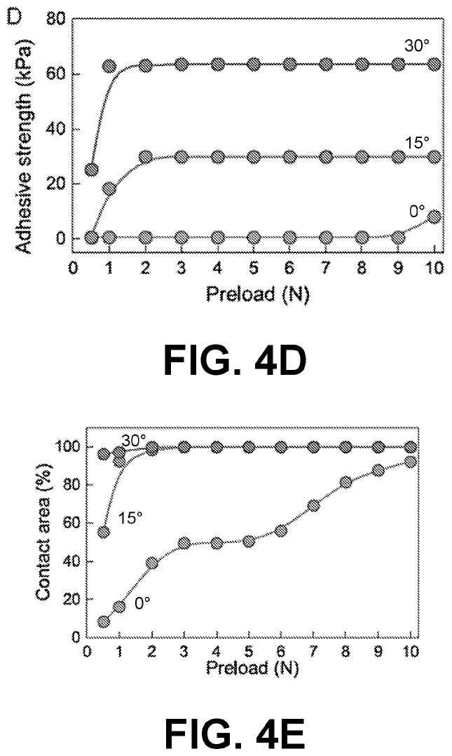

In unstructured environments, adhesives may not always be well aligned with substrates of interest. The misalignment tolerance of the adhesive elements 103 was studied by characterizing the adhesion properties against inclined substrates 203 with different angles relative to the plane of the adhesive element 103. FIG. 4A schematically illustrates the change of substrate angle from 0 to 10°. FIG. 4B presents the adhesive strength as a function of substrate angle ranging between 0-12.5° for same preload of 3 N (17 kPa). The adhesive strength of the α=30° stalk angle is maintained for inclined angles up to 5° and is the only element capable of adhering with a substrate inclination>10°. The α=0° adhesive element fails to achieve any adhesion above inclined angles of 5°, as the element is no longer able to create contact, highlighting the importance of compliance for contact generation.

The FE model was further utilized to characterize the deformation along the stalk 106 for different stalk angles (α). FIG. 4C shows the strain profiles along the stalk 106, where the location axis starts from the tip of membrane. The graph of FIG. 4C shows the strain percentage as a function of the location of the adhesive element under adhesion. The insets show the strain distribution on the FEA models for the deformed adhesive elements 103 with α=0° and α=30°. An equal displacement of 2.5 mm is used for all angles to compare strain profiles. The smaller angles (e.g., 0°) show relatively uniform strain distribution with high strain near the contact area (near the 0 mm position). Conversely, for larger stalk angle α (e.g., 30° or more), the strain is noticeably smaller near the contact location which gradually increases towards the base. This behavior indicates that adhesive elements 103 with larger a experience smaller strain near the contact zone while the thin region of the stalk 106 elongates significantly. The stress distribution also shows lower stress near the contact zone and greater stress in the thin stalk region for α=30°. These results indicate that the negligible strain of the α=30° adhesive element 103 near the contact area ensures minimal disturbance of the flexible membrane 109 for robust adhesion performance, even when the adhesive element 103 is significantly misaligned.

Next, a constant substrate angle of 5° was used to examine the adhesive strength dependence on preload. Here, the amount of preload was increased from 0.5 to 10 N and the maximum adhesive strength was reported for each stalk angle. The graph of FIG. 4D illustrates the adhesion strength dependence on preload evaluated on the substrate angle of 5°. FIG. 4D shows that the α=30° adhesion element 103 achieved adhesion even for a low preload of 0.5 N (2.8 kPa) and then reached a maximum adhesion strength above 60 kPa for 1 N (5.7 kPa) preload. For the α=15° element, adhesive strength begins to develop for the 1 N preload and then plateaued at a moderate adhesive strength of 30 kPa at a 2 N preload. The 0° adhesive element 103 needed at least 10 N preload to develop any adhesion strength, and even at that point only shows a low adhesion strength of 10 kPa, significantly smaller than the more compliant elements.

The preload on adhesive elements 103 is an important factor for creating contact with the substrate. This was further examined using FE analysis to determine contact area as a function of preload. Here, the contact area was calculated as a ratio of contact nodes to total nodes of the membrane 109 during compression of adhesive elements 103 onto a 5° inclined surface. The summarized contact area analysis for α=0°, 15°, and 30° are presented in FIG. 4E, which illustrates the percentage of contact area on the 5° substrate as a function of preload. By comparing the adhesive strength and contact area in FIG. 4E, it can be seen that successful adhesion develops when 90% of the adhesive element 103 is in contact with the substrate. This condition can be interpreted as the minimum contact area needed to ensure the membrane component is in contact with the substrate. The stiffer α=0° and 15° adhesive elements 103 need a high preload to satisfy the contact area condition to initiate adhesion with inclined substrates. In contrast, the highly flexible adhesive elements 103 having α=30° can meet the contact area requirement with low preload. This reduced preload is considerably advantageous as it allows for robust contact and strong underwater adhesion without pressing hard into substrates. These results are clear indicators of the conformal adhesion mechanism of the octopus-inspired adhesive elements 103 and point to the importance of stalk design to strongly adhere underwater in unstructured environments.

### Adhesive Skin for Underwater Gripping and Manipulation

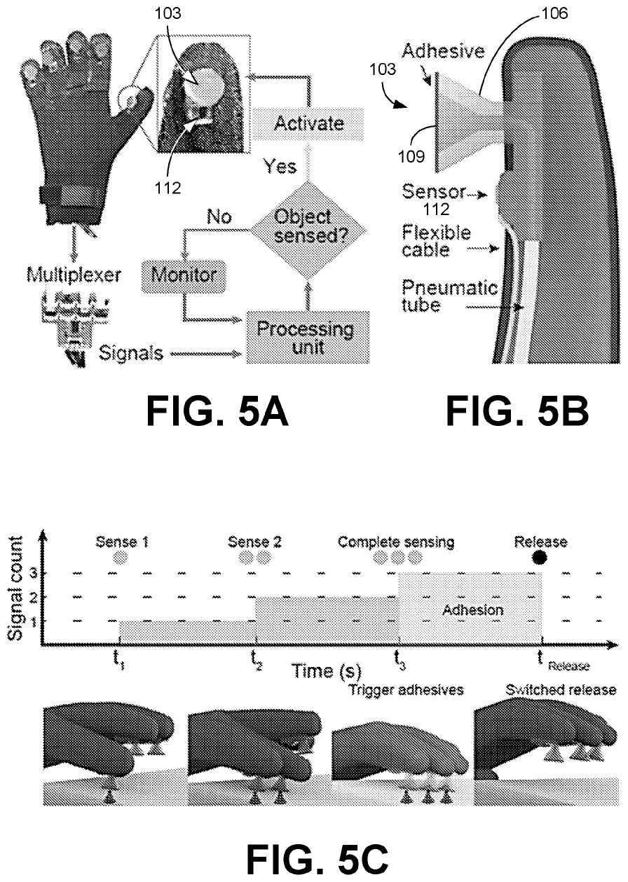

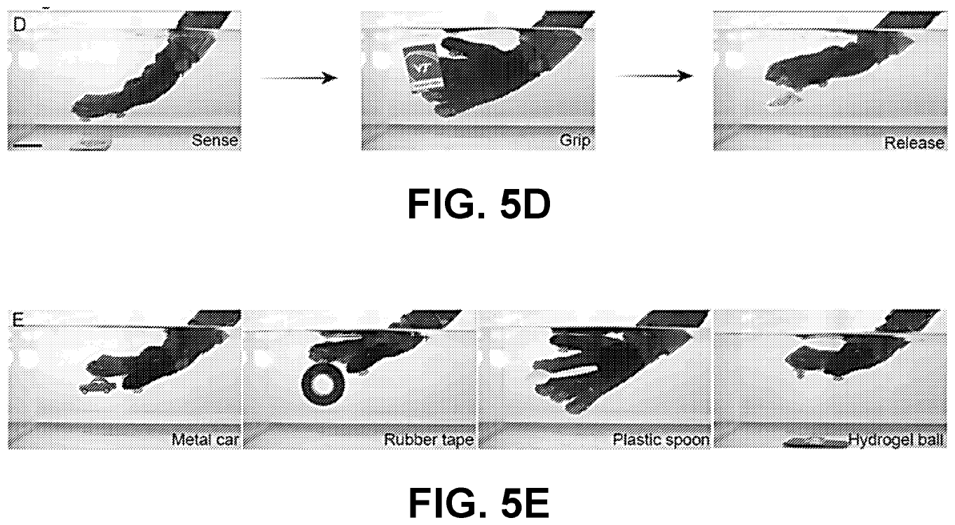

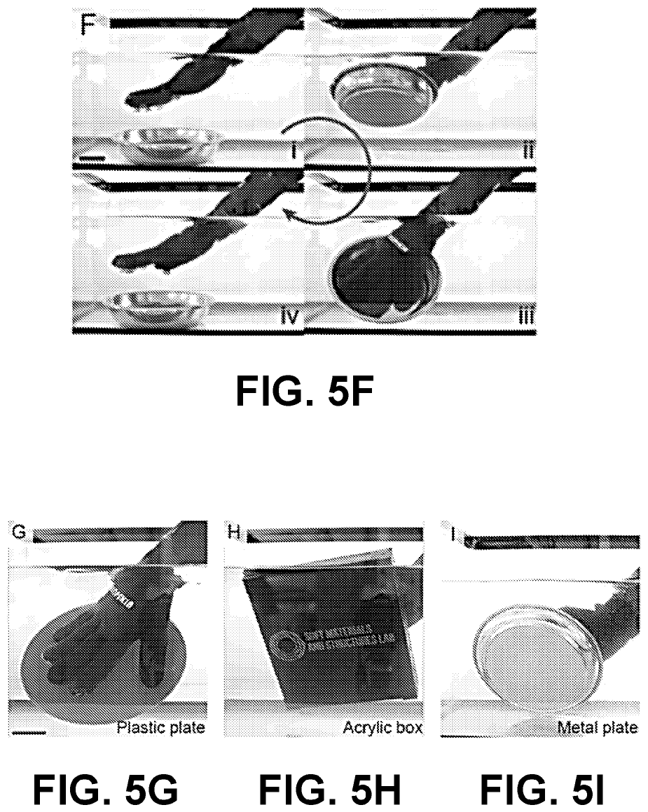

The octopus-inspired adhesive elements 103 were tightly integrated with a sensorized skin to create a wearable glove for autonomous adhesion control and dexterous manipulation of underwater objects. FIG. 5A illustrates an example of a wearable adhesive glove with integrated adhesive elements, sensors, processing, and control showing the logic layout to activate adhesion. Each finger of the glove can comprise an active adhesive element 103 and micro-LIDAR optical sensor 112 for proximity detection. The array of optical proximity sensors 112 can be connected to a microcontroller 115 or other processing circuitry using, e.g., a multiplexer where the proximity data can be collected to determine if an object has been detected. If an object is within a defined sensing range of the proximity sensor 112, a digital signal can be sent to activate a solenoid-controlled pneumatic device (e.g., trigger or valve) for rapid activation of the adhesive elements 103. A cross section of a finger from the sensorized glove including the embedded sensor 112 and adhesive element 103 is shown in FIG. 5B. An optical proximity sensor 112 was fixed to the elastomeric platform that contained the adhesive element 103. A flexible sensor cable and pneumatic tube can be routed inside the glove.

Adhesion with complex geometry was aided by the ability of α=30° adhesive elements 103 to conform to a surface with a small preload. Sensorized gripping with the glove is illustrated in FIG. 5C by a sequence of schematics and corresponding time plot. The sequence of the sensorized adhesive elements 103 shows the adhesion triggering after complete sensing by three sensors 112 followed by switched release. Different adhesive activation modes can be achieved by controlling the proximity range for object detection and actuation timing for a selected group of sensors. For instance, the adhesive elements can be programmed to activate after three sensors 112 detect an object as shown in FIG. 5C. Notice that the adhesive elements 103 are inactive in the first three sensing instances (t<t₃). When three sensors 112 recognize a substrate at t₃ a digital signal is sent to actuate the pneumatic trigger, which initiates rapid adhesion. The release can also be performed by switching off the adhesive element 103 at t_{Release}.

Both the sensorized skin and adhesive elements function while submerged, enabling the wearable glove to manipulate diverse objects underwater. To manipulate delicate and lightweight objects, a single sensor mode can be utilized to activate the adhesive elements 103. FIG. 5D includes images showing that the index finger can recognize a small card and trigger adhesion. A single adhesive activation mode can be used to sense, grip, and release the lightweight paper card in the underwater environment. The negatively pressurized adhesive element 103 attaches to the card and then the user rotates their hand to show the logo in the middle image of FIG. 5D. The card can then be released on demand as shown in the right image of FIG. 5D. The images of FIG. 5E show underwater manipulation of other small and lightweight items with different shapes and materials. The underwater manipulation with a single adhesive element 103 and sensor 112 to adhere and pickup, e.g., a metal car, a metal toy car, cylindrical rubber tape, the doubly curved convex portion of a plastic spoon, and an ultrasoft hydrogel ball. FIG. 5E demonstrates adhesion to flat, cylindrical, convex, and spherical surfaces across hard and soft materials.

It is also possible to grip larger objects with a combination of adhesive elements 103 by reconfiguring the sensor network to utilize all sensors 112 for object detection. Here, the microcontroller 115 can be programmed to actuate the pneumatic trigger after a combination of three of the sensors 112 detect the proximity of an object within a defined sensing distance. This mode ensures contact of all the adhesive elements 103 with the substrate or object before activating adhesion. FIG. 5F shows the use of a fully-functional adhesive glove for gripping the concave surface of a metal bowl. The images of FIG. 5F demonstrate the use of multiple adhesive elements 103 and sensors 112 on the adhesive glove to grip, lift, and release the large metal bowl in water. The adhesives approach the object as shown in image (i) of FIG. 5F and then autonomously activate adhesion to enable easy lifting and handling of the bowl as shown in images (ii) and (iii) of FIG. 5F before activating release as shown in image (iv) of FIG. 5F. This functionality is repeated in FIGS. 5G, 5H and 5I to manipulate a plastic plate, an acrylic box, and a metal plate, demonstrating dexterous underwater manipulation of different materials with a range of surface reflectivity. All scale bars are 5 cm in FIGS. 5D-5I.

An octopus-inspired underwater manipulation system has been introduced by tightly integrating sensing, processing, and control with rapidly switchable adhesives. This is enabled by adhesive elements 103 that switch adhesion 450× from the ON to OFF state quickly (<0.1 s) with the ability to be reused over multiple cycles. By tuning sucker compliance through the stalk architecture, reliable attachment can be achieved in unstructured environments at low preloads. This functionality was demonstrated in a wearable adhesive glove to autonomously activate adhesion to pick and release a variety of items underwater including flat, curved, rigid, and soft objects. These capabilities mimic the advanced manipulation, sensing, and control of cephalopods and provide a platform for synthetic underwater adhesive skins that can manipulate diverse underwater objects.

One of the enabling features of this octopus-inspired adhesive system is real-time object detection coupled with rapidly switchable adhesives. This allowed for manipulation of diverse objects at time scales relevant to human movement. This was achieved due to the low preload needed to activate adhesion on different substrates by optimizing the architecture of the adhesive stalk 106. This low preload adhesive activation coupled with the object detection enables this octopus-inspired adhesive system to provide real-time object detection coupled with rapidly switchable adhesives. This allows manipulation of diverse objects at time scales relevant to human movement. This can be achieved due to the low preload needed to activate adhesion on different substrates by optimizing the architecture of the adhesive stalk 106. This low preload adhesive activation coupled with the object detection through sensing and rapidly switchable adhesives is an important combination to achieve underwater manipulation with autonomous gripping and release.

Tuning stalk compliance also enables independent control of adhesive strength and toughness. This increase in toughness can be achieved while maintaining the ability to rapidly release objects. This combination is unusual as higher adhesion toughness is typically achieved with enhanced inelastic dissipation, which can make release difficult and typically increases switching time. Therefore, control over adhesive strength, toughness, and release is important for efficient manipulation. The strength allows for relatively heavier objects to be manipulated, the toughness allows for tolerance to perturbations during manipulation where the adhesive element 103 can deform while still grasping the object, and the ability to trigger a low adhesive state allows for objects to be released despite the higher strength and toughness. This combination of controlling strength and toughness with rapid release is an exceptional combination of adhesive properties that is achieved in this system and is extremely advantageous for underwater manipulation. Evaluation of negative/positive pneumatic pressure differential, membrane geometry, stalk geometry, water depth, and object characteristics can establish the full range of ON/OFF ratio characteristics for the switchable adhesive elements 103. Furthermore, microfabrication strategies can enable device downscaling and integration with microfluidic channels which can allow for multiplexing the pneumatic system.

Although this study is focused on optical sensors, different sensing modalities can also be employed. Chemical or mechanical sensors can be synergistic, and can offer a diverse set of vision, chemical, and mechanical sensing during manipulation. Haptic feedback can also be integrated into this system to alert a user when adhesive elements 103 are activated (e.g., by including an internal feedback surface in the fingers of the glove) and this can allow for tuning of the control scheme for customizable underwater manipulation. Further, while the use of pneumatic activation for the adhesive elements 103 was the focus of this disclosure, other types of switchable adhesives may be utilized with the understanding that keeping the switching time (i.e., the time to activate or release the adhesive element) on the order of seconds or less allows for active manipulation without needing to prime the system or wait extended amounts of time in contact. The octopus-inspired adhesive skin can also be deployed as an untethered system. For example, untethered soft material actuation can utilize pneumatic systems (e.g., pumps, valves, electronics, batteries) on the order of 500 g that can be carried by or within a soft robot itself. Miniature pumps can run on 10 W and it has been shown that low power soft pumps can consume as little as 100 mW. The pneumatic membrane in adhesive elements 103 can provide a closed system which could allow for the pneumatic system to be powered off after activation (i.e., with no power consumed during gripping/manipulation) which can provide power savings. The disclosed adhesive system 100 can be used for robotic manipulation, manufacturing, and health care for programmed or autonomous manipulation of surfaces, materials, and tissues in dry or wet environments.

### Materials and Methods

Adhesive Element Manufacturing and Preparation: Molds were created from a DLP 3D printer (B9 Creations) with variations in the stalk angles α of: 0, 15, 30° with a sucker diameter of 15 mm. The adhesive elements 103 were fabricated with Polydimethlysiloxane (PDMS) (Sylgard 184 with a 10:1 ratio), by pouring elastomer into 3D-printed molds and curing at 80° C. for 8 hours. The PDMS was removed and treated with oxygen plasma for 1 minute prior to placement onto a 500 μm silicone membrane 109 (Dragon Skin 00-30, Smooth-On), which was partially cured at 80° C. for 2 minutes. The adhesive element 103 and partially cured membrane 109 were cured at 80° C. for 4 hours. A 20-gauge needle attached with pneumatic tubing, was inserted into the base of each sample where an air channel was located. A silicone adhesive (Sil-Poxy, Smooth-On) was used to seal the inserted needle to the sample.

Adhesive Testing: Adhesive elements 103 were tested through normal adhesion experiments on an Instron 5944 load frame. Adhesive elements 103 were lowered onto an acrylic substrate and compressed to a force of 3 N or about 17 kPa and held for five seconds while the desired pneumatic state was activated. The sample was then retracted at a rate of 1 mm/s until separation from the substrate. Each sample was tested with positive pressure, neutral pressure, and 27, 53 and 88 kPa of negative pressure. An additional test was conducted outside of water with the same set up to determine the effects of a dry substrate. Angled substrate tests were performed with a tilted, acrylic substrate at angles of 2.5, 5, 7.5, 10, and 12.5°. Each sample was lowered onto the substrate with a preload of 3 N and subjected to the maximum negative pressure of 88 kPa.

Finite Element Analysis: The computational models of adhesive elements 103 were developed using the finite element (FE) analysis program ABAQUS/Standard (SIMULIA, Providence, RI) as 3D deformable bodies. 8-node linear brick elements C3D8R, which uses reduced integration with enhanced hourglass control, were utilized. An adhesive element with a stalk angle α=30° was considered for stress and strain profiles. The stalk 106 (PDMS) and membrane 109 (Dragon Skin) of the adhesive element 103 were formulated using hyperelastic Yeoh model53 materials. The material coefficients C₁₀=0.19 MPa, C₂₀=0.21 MPa, C₃₀=0.01 were used for PDMS and C₁₀=0.37 MPa, C₂₀=0.005 MPa, C₃₀=0 were employed for Dragon Skin. The semi-rigid adhesion contact was replicated using spring boundary condition (1 N/mm for each spring) at the bottom surface of the membrane 109. This value was tuned to fit with the experimental result.

The contact area analysis in FE was performed using the same material properties for the adhesive element 103. However, the membrane boundary conditions were changed to a friction contact between the adhesive surface and the inclined substrate. A nonlinear friction coefficient was used as a function of preload, which was used for the analysis of all stalk angles.

Wearable adhesive glove: The wearable adhesive glove was developed from a neoprene wetsuit glove (e.g., 3 mm NeopSkin Water Gloves) which hosts the adhesive elements 103 and sensors 112 in each finger. The adhesive elements 103 were cut into rectangular pieces to fit the glove fingers and flexible pneumatic tubings with 0.8 mm ID were inserted at the base of the adhesive elements 103. The sensing in the glove was achieved using a micro-LIDAR optical sensor (e.g., STMicroelectronics VL6180X) that is wired together using flat flexible cables (Molex). A sensor 112 was attached to each adhesive element 103 (see FIG. 5A) using silicone adhesive (Smooth-On Sil-Poxy) with an unobstructed field of view. The sensors 112 and flat flexible cable joints were spray-coated with a thin, waterproof layer of conformal coating (e.g., Humiseal 1A33 Aerosol). The pneumatic tubes from the adhesive elements 103 were combined using a heat shrink wrap and fit to a solenoid valve (e.g., Spartan Scientific 2-Way/2-Position Valve) through a plastic tube (e.g., PureSec CCK RO Tubing). The inlet of the solenoid valve was attached to a vacuum pump. Multiple optical sensors 112, which have a fixed I2C address, were connected to a single microcontroller 115 (e.g., Microchip ATmega2560) using a bidirectional multiplexer (Texas Instruments TCA9548). The microcontroller 115 is used to control the solenoid operated pneumatic system based on the optical sensor network feedback.

In addition to a glove, systems of adhesive elements 103 and sensing elements 112 can be integrated on a surface of other clothing or a device. Adhesive systems can also be attached to a vehicle (e.g., a ship, sub, etc.) and may be attached to a dock or other surface. In addition, adhesive systems can be utilized on a robotic system to enhance gripping and manipulation or placed on surfaces or features in a manufacturing environment. In some embodiments, an adhesive system may be placed directly on skin.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

1. An underwater adhesive system, comprising:
a plurality of switchable adhesive elements, each of the plurality of switchable adhesive elements pneumatically actuated to control adhesion or release of that switchable adhesive element;
a plurality of proximity sensing elements positioned in proximity to the plurality of proximity sensing elements; and
a controller communicatively coupled to the plurality of proximity sensing elements, the controller configured to control adhesion of the plurality of switchable adhesive elements based at least in part upon signals from the plurality of proximity sensing elements.

2. The underwater adhesive system of claim 1, wherein the controller autonomously controls the adhesion of one or more of the plurality of switchable adhesive elements in response to the signals from one or more corresponding proximity sensing elements.

3. The underwater adhesive system of claim 1, wherein individual elements of the plurality of switchable adhesive elements comprise a compliant stalk having a distal end capped with a pneumatically actuated membrane.

4. The underwater adhesive system of claim 3, wherein the compliant stalk is an elastomer stalk.

5. The underwater adhesive system of claim 3, wherein application of a negative pressure adheres the individual element to the object.

6. The underwater adhesive system of claim 5, wherein application of a positive pressure releases the individual element from the object.

7. The underwater adhesive system of claim 5, wherein the individual element is released from the object when the negative pressure is removed and a neutral pressure is reached.

8. The underwater adhesive system of claim 1, wherein the plurality of proximity sensing elements is an array.

9. The underwater adhesive system of claim 1, wherein one of the plurality of switchable adhesive elements is positioned adjacent to each of the plurality of proximity sensing elements.

10. The underwater adhesive system of claim 1, wherein the plurality of proximity sensing elements comprise optical proximity sensors.

11. The underwater adhesive system of claim 10, wherein the optical proximity sensors utilize laser-based sensing, camera-based vision sensing, or sound-based range sensing.

12. The underwater adhesive system of claim 10, wherein the optical proximity sensors comprise micro-LIDAR optical proximity sensors.

13. The underwater adhesive system of claim 1, wherein the plurality of proximity sensing elements and the plurality of switchable adhesive elements are integrated on a clothing surface or a device surface.

14. The underwater adhesive system of claim 13, wherein the plurality of proximity sensing elements and the plurality of switchable adhesive elements are integrated on a glove.

15. A switchable adhesive element, comprising:
a compliant stalk extending from a support end affixed to a supporting surface to a contact end opposite the support end, the compliant stalk tapers outward at a stalk angle adjacent to the contact end; and
an actuated membrane capping the contact end of the compliant stalk, the actuated membrane actuated in response to detection of a surface of an object by a proximity sensing element adjacent to the compliant stalk.

16. The switchable adhesive element of claim 15, wherein the stalk angle is about 15 degrees or more.

17. The switchable adhesive element of claim 16, wherein the stalk angle is about 30 degrees or more.

18. The switchable adhesive element of claim 15, wherein the actuated membrane is pneumatically actuated via an air channel extending through the compliant stalk.

19. The switchable adhesive element of claim 18, wherein application of a negative pressure adheres the switchable adhesive element to the surface of the object.

20. The switchable adhesive element of claim 15, wherein the proximity sensing element comprises an optical proximity sensor.

21. (canceled)
